(19) United States
(12) Patent Application Publication
(10) Pub. No.: US 2013/0217380 A1
(43) Pub. Date: Aug. 22, 2013

(54) METHOD OF DISPLAYING MOBILE TERMINAL IN REMOTE DEVICE AND APPARATUS FOR PERFORMING THE SAME

(71) Applicant: RSUPPORT Co., Ltd., (US)

(72) Inventors: Hyung Su SEO, Gyeonggi-do (KR); Myoung Seop KIM, Gyeonggi-do (KR)

(73) Assignee: RSUPPORT CO., LTD., Seoul (KR)

(21) Appl. No.: 13/775,067

(22) Filed: Feb. 22, 2013

(30) Foreign Application Priority Data
Feb. 22, 2012 (KR) 10-2012-0017772

(51) Int. Cl. H04W 4/00

(52) U.S. Cl. CPC H04W 4/001
USPC 455/420

(57) ABSTRACT

Disclosed are a method of remotely displaying a mobile terminal and an apparatus for performing the same. The remote display apparatus receives display information of the mobile terminal from the mobile terminal, obtains an external appearance image of the mobile terminal on the basis of the received display information of the mobile terminal, and displays an entire image of the mobile terminal that includes the obtained external appearance image of the mobile terminal and display screen information supplied from the mobile terminal.

### CLAIM FOR PRIORITY

This application claims priority to Korean Patent Application No. 10-2012-0017772 filed on Feb. 22, 2012 in the Korean Intellectual Property Office (KIPO), the entire contents of which are hereby incorporated by reference.

### BACKGROUND

1. Technical Field

Example embodiments of the present invention relate in general to the remote control of a mobile terminal and more specifically to a method of remotely displaying a mobile terminal, which displays an external appearance and display screen of a mobile terminal connected over a communication network.

2. Related Art

Remote control is technology for locally accessing and controlling faraway or distributed computers over a communication network, and is technology that enables a specific computer to access a control target computer over the Internet or an intranet and then control all functions of the control target computer while looking at an execution screen of the control target computer.

The remote control provides the above-described convenience, and thus is widely used by personal users as well as businesses. In the remote control, for example, businesses monitor and manage the use of computers therein, and moreover, cases are increasing in which personal users remotely access and use their workplace computers with home computers or remotely access and use their home computers with the workplace computers.

Recently, as the use of the Internet is generalized by using mobile terminals such as smart phones, applications that enable a personal computer (PC) to remotely control a smart phone are being actively developed.

For example, technology that connects a computer and a smart phone over a wireless network, displays a display screen of the smart phone on the computer, and remotely controls the smart phone while showing the display screen of the smart phone displayed by the computer is being recently used for correcting and managing the errors of smart phones.

However, in remotely controlling a smart phone with a computer as described above, since the computer displays only a display screen of the smart phone without displaying an actual appearance of the smart phone, a user cannot intuitively know the type of the smart phone.

Moreover, in a conventional remote control operation, since a display screen of a smart phone is displayed in a fixed size by a computer, a user cannot adjust the size of the display screen. Generally, considering that display-screen resolutions of computers are higher than those of smart phones, performing work using a display screen of a computer having high resolution while looking at a display screen of a smart phone having low resolution causes a reduction in a user's work efficiency.

### SUMMARY

Accordingly, example embodiments of the present invention are provided to substantially obviate one or more problems due to limitations and disadvantages of the related art.

Example embodiments of the present invention provide a method of remotely displaying a mobile terminal, which can enhance convenience in use.

Example embodiments of the present invention also provide an apparatus for remotely displaying a mobile terminal, which can enhance convenience in use.

In some example embodiments, a method of remotely displaying a mobile terminal, which is performed by an apparatus remotely connected to the mobile terminal, includes: receiving display information of the mobile terminal from the mobile terminal; obtaining an external appearance image of the mobile terminal on the basis of the received display information of the mobile terminal; and displaying an entire image of the mobile terminal that includes the obtained external appearance image of the mobile terminal and display screen information supplied from the mobile terminal.

The method may further include, after the displaying of the entire image, when an event indicating size change of the displayed entire image of the mobile terminal occurs, maintaining a size ratio of image objects included in the displayed entire image of the mobile terminal and a relative position between the image objects, and changing a size of the displayed entire image of the mobile terminal.

The receiving of the display information may include receiving identification information of the mobile terminal which is used for obtaining the external appearance image of the mobile terminal.

The obtaining of the external appearance image may include obtaining the external appearance image of the mobile terminal corresponding to the identification information from a pre-built database, or obtaining the external appearance image of the mobile terminal corresponding to the identification information over a network.

The displaying of the entire image may include detecting a region, in which a display element of the mobile terminal is displayed, from the external appearance image of the mobile terminal, and displaying the display screen of the mobile terminal in the detected region to display the entire image of the mobile terminal.

In other example embodiments, an apparatus for remotely displaying a mobile terminal includes: a communication unit configured to establish a connection with a mobile terminal, and receive display information from the mobile terminal; a storage unit configured to store an external appearance image of the mobile terminal corresponding to the display information; a processing unit configured to obtain the external appearance image of the mobile terminal from the storage unit on the basis of the display information, and perform control to display an entire image of the mobile terminal that includes the obtained external appearance image and a display screen of the mobile terminal supplied from the mobile terminal; and a display unit configured to display the entire image of the mobile terminal according to the control by the processing unit.

After the entire image of the mobile terminal is displayed, when an event indicating size change of the displayed entire image of the mobile terminal occurs, the processing unit may maintain a size ratio of image objects included in the displayed entire image of the mobile terminal and a relative position between the image objects, and change a size of the displayed entire image of the mobile terminal.

The display information of the mobile terminal may include identification information of the mobile terminal which is used for obtaining the external appearance image of the mobile terminal.

The processing unit may detect a region, in which a display element of the mobile terminal is displayed, from the external appearance image of the mobile terminal, and perform control such that the entire image of the mobile terminal is displayed by displaying the display screen of the mobile terminal in the detected region.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating a method of remotely displaying a mobile terminal according to an embodiment of the present invention;

FIG. 2 is a conceptual diagram for describing the method of remotely displaying a mobile terminal according to an embodiment of the present invention; and

FIG. 3 is a block diagram illustrating a configuration of an apparatus for remotely displaying a mobile terminal according to an embodiment of the present invention.

### DESCRIPTION OF EXAMPLE EMBODIMENTS

The invention may have diverse modified embodiments, and thus example embodiments are illustrated in the drawings and are described in the detailed description of the invention.

However, this does not limit the invention to specific embodiments and it should be understood that the invention covers all the modifications, equivalents, and replacements within the idea and technical scope of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, in embodiments of the present invention, a mobile terminal denotes all portable or mobile terminals such as smart phones, portable phones, pad type terminals, game machines that include a wired or wireless communication interface.

Moreover, in embodiments of the present invention, a remote display apparatus may be used to refer to any apparatus including a display apparatus that remotely accesses a mobile terminal through a wired or wireless communication interface, processes information, and displays the result of information processing. For example, in embodiments of the present invention, an apparatus for performing the remote display of a mobile terminal may include a stationary computer, a notebook computer, and a pad type terminal.

Hereinafter, example embodiments of the invention will be described in detail with reference to the accompanying drawings. In describing the invention, to facilitate the entire understanding of the invention, like numbers refer to like elements throughout the description of the figures, and a repetitive description of the same element is not provided.

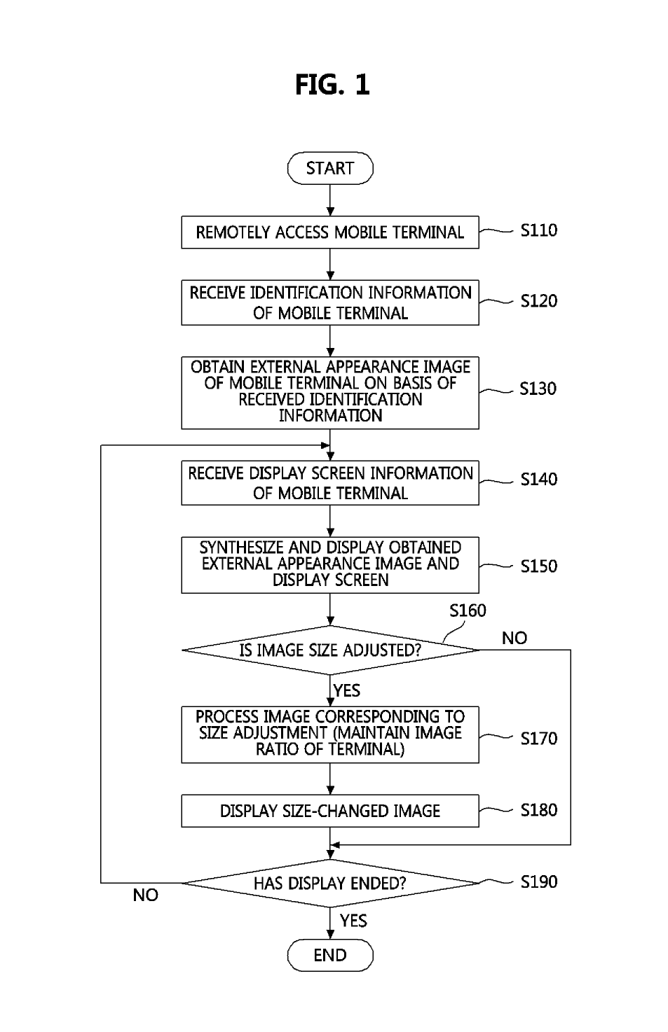

FIG. 1 is a flowchart illustrating a method of remotely displaying a mobile terminal according to an embodiment of the present invention, and illustrates a method performed by a remote display apparatus that has remote access to a specific mobile terminal over a wired or wireless network.

Referring to FIG. 1, a remote display apparatus remotely accesses a mobile terminal in operation S110. Here, for reliable access between the remote display apparatus and the mobile terminal, the remote display apparatus may authenticate the mobile terminal, or the mobile terminal may authenticate the remote display apparatus, and then the remote display apparatus and the mobile terminal may perform access therebetween. Alternatively, the remote display apparatus and the mobile terminal may perform authentication through a separate authentication server.

As described above, when the remote display apparatus and the mobile terminal have accessed each other remotely, the remote display apparatus receives identification information enabling the identification of the mobile terminal from the mobile terminal in operation S120. Here, for example, the identification information of the mobile terminal may include model information and a universally unique identifier (UUID) of the mobile terminal and a telephone number assigned to the mobile terminal, and may be used for determining the type of the mobile terminal.

Subsequently, the remote display apparatus obtains an external appearance image of the mobile terminal on the basis of the identification information received from the mobile terminal in operation S130. Here, the remote display apparatus may include a database that stores model information of mobile terminals corresponding to identification information of the mobile terminals and external appearance images by model (or type) of the mobile terminals, in which case the remote display apparatus may search the database to find type information of a mobile terminal corresponding to received identification information of the mobile terminal and obtain an external appearance image of the mobile terminal corresponding to the found type of the mobile terminal.

Alternatively, when the remote display apparatus does not include a database that stores external appearance images by type of mobile terminals, the remote display apparatus may obtain an external appearance image of a mobile terminal corresponding to identification information received from the mobile terminal through a separate database server or an external search engine over a communication network.

The remote display apparatus receives display screen information of the mobile terminal in operation S140. Here, the display screen information of the mobile terminal may be screen information which is being currently displayed by a display element (for example, a Liquid Crystal Display (LCD)) included in the mobile terminal, or, when the display element of the mobile terminal is turned off, the display screen information may be display information (for example, a standby screen) which would be displayed if the display element of the mobile terminal were turned on.

Operation S140 may be performed simultaneously with operation S120. That is, the remote display apparatus and the mobile terminal access each other remotely, and then the mobile terminal may simultaneously transmit identification information and display screen information to the remote display apparatus, in which case the mobile terminal may transmit the identification information and the display screen information using a separate predetermined data transmission format.

When the remote display apparatus has obtained the external appearance image of the mobile terminal corresponding to the identification information received from the mobile terminal as described above, the remote display apparatus processes the obtained external appearance image and display screen information of the mobile terminal to synthesize the external appearance image and the display screen information such that the display screen information of the mobile terminal is displayed in a display element region of the external appearance image of the mobile terminal, and displays the synthesized entire image of the mobile terminal in operation S150.

Here, the remote display apparatus detects the display element region from the obtained external appearance image of the mobile terminal through image processing, and, by allowing the display screen of the mobile terminal (which is received from the mobile terminal in real time) to be displayed in the detected display element region, the remote display apparatus may display the entire image of the mobile terminal which is obtained by synthesizing the external appearance image and display screen of the mobile terminal. Also, the remote display apparatus may adjust the display screen size of the mobile terminal according to the size (or resolution) of the obtained external appearance image of the mobile terminal and then display the entire image of the mobile terminal, or may adjust the external appearance image of the mobile terminal according to the display screen size of the mobile terminal and then display the entire image of the mobile terminal.

Subsequently, the remote display apparatus determines whether an event indicating the size adjustment of the displayed entire image of the mobile terminal occurs in operation S160. When the event indicating the size adjustment of the displayed entire image of the mobile terminal occurs, the remote display apparatus maintains a size ratio of image objects included in the entire image of the mobile terminal and performs image processing for adjusting the entire image size of the mobile terminal in operation S170.

For example, when the entire image of the mobile terminal includes image objects such as a case border (or bezel), a display element (for example, LCD), buttons, a microphone, and a speaker, the remote display apparatus adjusts the entire image size of the mobile terminal without changing a ratio between the image objects. Here, the remote display apparatus may change the entire image size of the mobile terminal in an image processing scheme such as interpolation or extrapolation.

The remote display apparatus changes the image size of the mobile terminal as described above, and displays the size-changed image in operation S180.

Then, the remote display apparatus determines whether an event indicating the end of the image display of the mobile terminal occurs in operation S190. When the event indicating the end of the image display of the mobile terminal occurs, the remote display apparatus ends the image display of the mobile terminal, but when the event indicating the end of the image display of the mobile terminal does not occur, the remote display apparatus returns to operation S140 and performs subsequent operations.

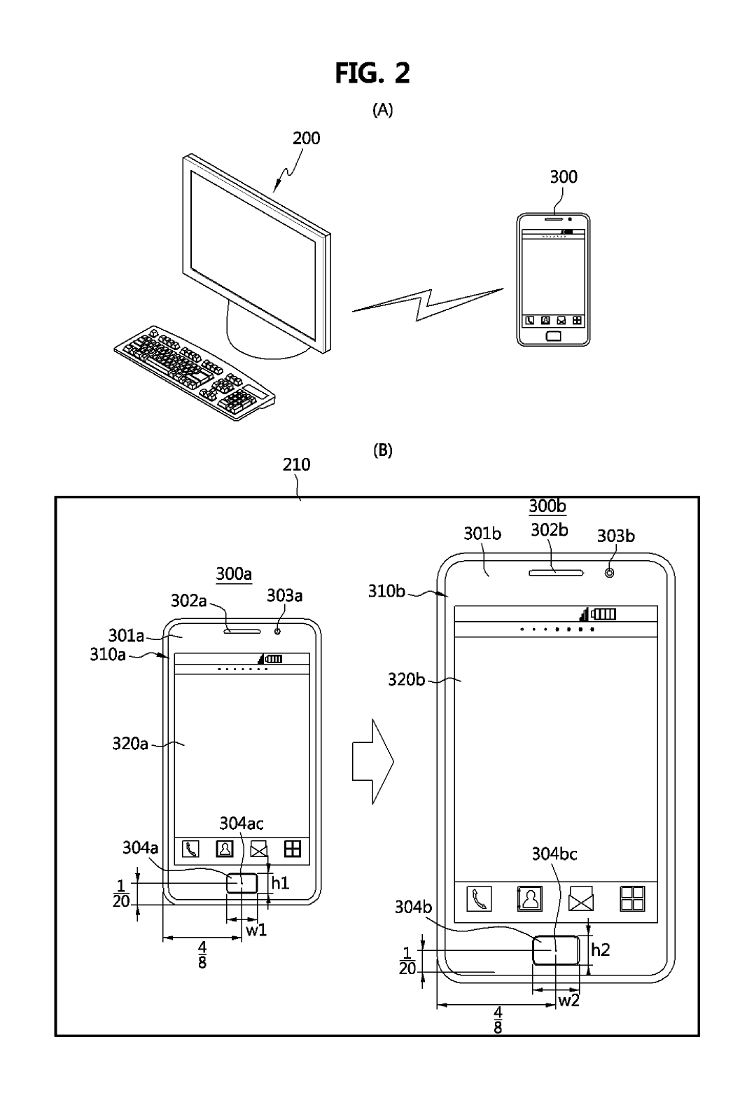

FIG. 2 is a conceptual diagram for describing the method of remotely displaying a mobile terminal according to an embodiment of the present invention. FIG. 2A illustrates an environment in which the remote display method is performed, and FIG. 2B is a conceptual diagram for describing a method for changing an entire image of a mobile terminal displayed by a remote display apparatus in an operation of remotely displaying the mobile terminal.

Referring to FIG. 2, when a remote display apparatus 200 and a mobile terminal 300 have accessed each other remotely, the remote display apparatus 200 displays an entire image 300a of the mobile terminal 300 on a display screen 210 thereof on the basis of information received from the mobile terminal 300. Here, when the mobile terminal 300 has remotely accessed the remote display apparatus 200 and then the remote display apparatus 200 displays the entire image 300a of the mobile terminal 300 for the first time, the remote display apparatus 200 may display the entire image of the mobile terminal 300 in a predetermined size (for example, an actual size).

The entire image 300a of the mobile terminal 300 may include an external appearance image 310a of the mobile terminal 300 and a display screen 320a displayed in a display element region of the mobile terminal 300. Here, the external appearance image 310a may be the actual image of the mobile terminal 300, and the display screen 320a is a screen image displayed by the display element of the mobile terminal 300 and may be changed in correspondence to display screen information which is transmitted from the mobile terminal 300 in real time.

Subsequently, when a user of the remote display apparatus 200 changes the entire image 300a of the mobile terminal 300, the remote display apparatus 200 changes the size of the entire image 300a of the mobile terminal 300 in correspondence to the changed image size, and displays the changed entire image 300b of the mobile terminal 300.

Here, the remote display apparatus 200 maintains a ratio of the entire image of the mobile terminal 300, a size ratio of image objects included in the entire image, and a relative ratio between the image objects, and changes the entire image size of the mobile terminal 300.

For example, as illustrated in FIG. 2B, the entire image 300a of the mobile terminal 300 includes a bezel 301a, a speaker 302a, a camera 303a, a button 304a, and an image object of the display screen 310a, and when the entire image size of the mobile terminal 300 is enlarged, a size ratio of a bezel 301b, a speaker 302b, a camera 303b, a button 304b, and a display screen 310b which are included in the enlarged entire image 300b of the mobile terminal 300 and a position ratio between the image objects are maintained identically.

That is, when a ratio of width w1 and height h1 of the button 304a in the original entire image 300a is 3:2, the remote display apparatus 200 performs image processing such that a ratio of width w2 and height h2 of the button 304a in the enlarged entire image 300b becomes 3:2.

Moreover, in changing an entire image size of a mobile terminal, as described above, the remote display apparatus 200 performs image processing such that a size ratio of image objects is maintained identically to the original entire image and moreover a position ratio of the image objects is maintained identically to the original entire image.

For example, when a central position 304ac of the button 304a in the original entire image 300a is disposed at a portion corresponding to one twentieth of a height of the original entire image 300a and four eighths of a width of the original entire image 300a, the remote display apparatus 200 performs image processing such that a central position 304bc of the button 304b in the enlarged entire image 300b is disposed at a portion corresponding to one twentieth of a height of the enlarged entire image 300b and four eighths of a width of the enlarged entire image 300b.

As illustrated in FIG. 2, in the method of remotely displaying a mobile terminal according to an embodiment of the present invention, an entire image of a mobile terminal including an actual appearance image and display screen of the mobile terminal is displayed, and when the displayed entire image of the mobile terminal is reduced or enlarged, a size ratio and a relative position ratio of image objects included in the original entire image are maintained identically, thus enabling a user to intuitively recognize the kind of a remotely accessed mobile terminal. Also, even when an entire image of a mobile terminal displayed by the remote display apparatus is enlarged or reduced, the entire shape and characteristic of the mobile terminal can be maintained, thus enhancing service quality and work efficiency.

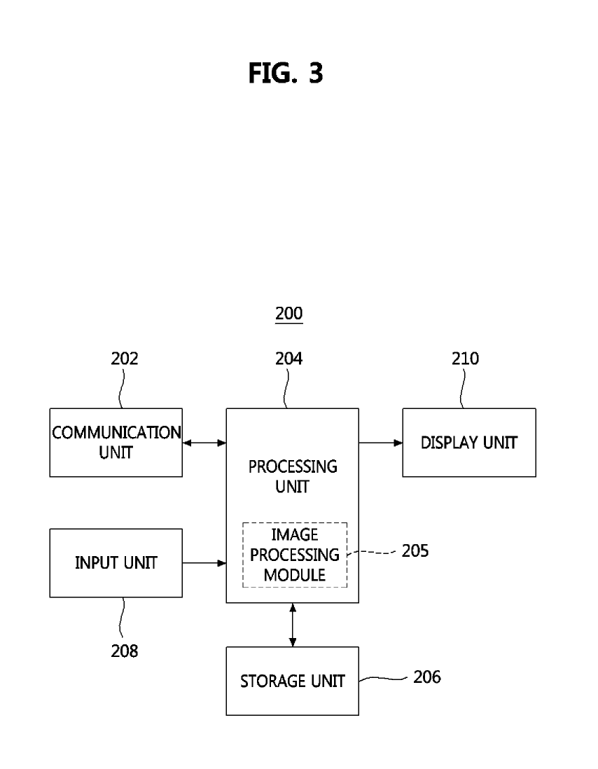

FIG. 3 is a block diagram illustrating a configuration of an apparatus for remotely displaying a mobile terminal according to an embodiment of the present invention.

Referring to FIG. 3, the remote display apparatus for a mobile terminal according to an embodiment of the present invention may include a communication unit 202, a processing unit 204, a storage unit 206, an input unit 208, and a display unit 210.

The communication unit 202 may include a network interface for performing wired or wireless data communication, and establish a connection with a mobile terminal according to control by the processing unit 204. Also, the communication unit 202 receives identification information and display screen information of the mobile terminal from the mobile terminal, processes the received information into a format recognizable by the processing unit 204, and supplies the processed information to the processing unit 204.

Here, for example, the identification information of the mobile terminal may include model information and a UUID of the mobile terminal and a telephone number assigned to the mobile terminal, and the identification information may be used for determining the type of the mobile terminal. Also, the display screen information of the mobile terminal may be screen information which is being currently displayed by a display element included in the mobile terminal, or, when the display element of the mobile terminal is turned off, the display screen information may be display information (for example, a standby screen) which would be displayed if the display element of the mobile terminal were turned on.

The processing unit 204 receives the identification information and display screen information of the mobile terminal from the mobile terminal through the communication unit 202, and obtains an external appearance image of the mobile terminal on the basis of the received identification information of the mobile terminal. Here, the processing unit 204 may search a database stored in the storage unit 206 to find model information of the mobile terminal corresponding to the identification information of the mobile terminal, and read an image corresponding to the found model of the mobile terminal from the storage unit 206.

Alternatively, when the database is not stored in the storage unit 206 or an image corresponding to the identification information of the mobile terminal is not stored in the storage unit 206, the processing unit 204 may obtain an external appearance image of the mobile terminal corresponding to the identification information of the mobile terminal from an external database server or an external search engine through the communication unit 202.

Moreover, the processing unit 204 processes the external appearance image and display screen image of the mobile terminal and thus allows the display screen information of the mobile terminal to be displayed in a region in which a display element is displayed in the external appearance image of the mobile terminal.

Here, the processing unit 204 may include an image processing module 205 for image processing. The image processing module 205 detects a display element region of the external appearance image of the mobile terminal, and by displaying the display screen (which is received from the mobile terminal in real time) of the mobile terminal in the detected display element region, the display unit 210 displays the entire image of the mobile terminal which is obtained by synthesizing the external appearance image and display screen of the mobile terminal.

Moreover, the processing unit 204 may adjust the display screen size of the mobile terminal according to the size of the external appearance image of the mobile terminal and then display the entire image of the mobile terminal, or adjust the external appearance image of the mobile terminal according to the display screen size of the mobile terminal and then display the entire image of the mobile terminal.

The processing unit 204 allows the display unit 210 to display the entire image of the mobile terminal as described above, and when an event indicating the size adjustment of the entire image is supplied from the input unit 208, as illustrated in FIG. 2, the processing unit 204 maintains a size ratio of image objects included in the entire image of the mobile terminal and a relative position between the image objects, changes the entire image size of the mobile terminal, and displays the changed entire image on a screen of the display unit 210.

Here, the processing unit 204 or the image processing module 205 thereof may change the entire image size of the mobile terminal in the image processing scheme such as interpolation or extrapolation.

The storage unit 206 may include a nonvolatile memory element, and store model information and/or external appearance images of mobile terminals corresponding to identification information of the mobile terminals.

For example, the storage unit 206 may store model names (or type information) and external image information by identification information of mobile terminals.

The input unit 208 may be configured with a keypad, a touch screen, or a touch panel, and supplies a key event signal, corresponding to the key or menu manipulation of a user, to the processing unit 204.

The display unit 210 may be configured with an LCD, a plasma display panel (PDP), or an organic light emitting diode (OLED), and displays an entire image of a mobile terminal supplied from the processing unit 204.

Alternatively, the input unit 208 and the display unit 210 may be configured with a single element such as a touch screen.

According to the method of remotely displaying a mobile terminal and the apparatus for performing the same, an external appearance and display screen of a remotely accessed mobile terminal are displayed identically to those of the actual mobile terminal, and when the image size of the displayed mobile terminal is changed, a size ratio of image objects included in the original image and relative positions of the respective image objects are identically maintained and the entire image size of the mobile terminal is changed and displayed.

Accordingly, a user can easily recognize the model or kind of a mobile terminal, and when the image size of a displayed mobile terminal is adjusted, only the size of the mobile terminal is changed without changing the actual appearance of the mobile terminal and the size-changed mobile terminal is displayed, thus enhancing convenience in use.

While the example embodiments of the present invention and their advantages have been described in detail, it should be understood that various changes, substitutions and alterations may be made herein without departing from the scope of the invention.

What is claimed is:

1. A method of remotely displaying a mobile terminal, which is performed by an apparatus remotely connected to the mobile terminal, the method comprising:
receiving display information of the mobile terminal from the mobile terminal;
obtaining an external appearance image of the mobile terminal on the basis of the received display information of the mobile terminal; and
displaying an entire image of the mobile terminal that comprises the obtained external appearance image of the mobile terminal and display screen information supplied from the mobile terminal.

2. The method of claim 1, further comprising, after the displaying of the entire image, when an event indicating size change of the displayed entire image of the mobile terminal occurs, maintaining a size ratio of image objects comprised in the displayed entire image of the mobile terminal and a relative position between the image objects, and changing a size of the displayed entire image of the mobile terminal.

3. The method of claim 1, wherein the receiving of the display information comprises receiving identification information of the mobile terminal which is used for obtaining the external appearance image of the mobile terminal.

4. The method of claim 3, wherein the obtaining of the external appearance image comprises obtaining the external appearance image of the mobile terminal corresponding to the identification information from a pre-built database, or obtaining the external appearance image of the mobile terminal corresponding to the identification information over a network.

5. The method of claim 1, wherein the displaying of the entire image comprises detecting a region, in which a display element of the mobile terminal is displayed, from the external appearance image of the mobile terminal, and displaying the display screen of the mobile terminal in the detected region to display the entire image of the mobile terminal.

6. An apparatus for remotely displaying a mobile terminal, comprising:
a communication unit configured to establish a connection with a mobile terminal, and receive display information from the mobile terminal;
a storage unit configured to store an external appearance image of the mobile terminal corresponding to the display information;
a processing unit configured to obtain the external appearance image of the mobile terminal from the storage unit on the basis of the display information, and perform control to display an entire image of the mobile terminal that comprises the obtained external appearance image and a display screen of the mobile terminal supplied from the mobile terminal; and
a display unit configured to display the entire image of the mobile terminal according to the control by the processing unit.

7. The apparatus of claim 6, wherein, after the entire image of the mobile terminal is displayed, when an event indicating size change of the displayed entire image of the mobile terminal occurs, the processing unit maintains a size ratio of image objects comprised in the displayed entire image of the mobile terminal and a relative position between the image objects, and changes a size of the displayed entire image of the mobile terminal.

8. The apparatus of claim 6, wherein the display information of the mobile terminal comprises identification information of the mobile terminal which is used for obtaining the external appearance image of the mobile terminal.

9. The apparatus of claim 6, wherein the processing unit detects a region, in which a display element of the mobile terminal is displayed, from the external appearance image of the mobile terminal, and performs control such that the entire image of the mobile terminal is displayed by displaying the display screen of the mobile terminal in the detected region.
